(19) United States
(12) Patent Application Publication
(10) Pub. No.: US 2003/0053763 A1
(43) Pub. Date: Mar. 20, 2003

(54) Optical module and method of producing the optical module

(76) Inventor: Katsuhiko Goto, Tokyo (JP)

Correspondence Address: Platon N. Mandros, BURNS, DOANE, SWECKER & MATHIS, L.L.P, P.O. Box 1404, Alexandria, VA, 22313-1404, US

(21) Appl. No.: 10/032,445

(22) Filed: Jan. 2, 2002

(30) Foreign Application Priority Data
Sep. 14, 2001 (JP) 2001-280271

(51) Int. Cl. G02B 6/42; G02B 6/30; G02B 6/26

(52) U.S. Cl. 385/88; 385/92; 385/49; 385/52

(57) ABSTRACT

An optical module is provided. The optical module comprises a photo receiver having a receiving surface, a first positioning member having a side surface to which the photo receiver is secured, and a second positioning member having a first groove formed in an upper surface thereof for positioning an optical fiber, and a second groove formed in the upper surface thereof, the second groove extending from a side surface of the second positioning member to the first groove and being connected to the first groove, the second groove having at least a part of the photo receiver housed therein, and the side surface of the first positioning member being secured to the side surface of the second positioning member. The second positioning member can include a position indicator for substantially indicating a position of a center of a light spot which is to be produced on the receiving surface of the photo receiver by light emitted out of an end of the optical fiber positioned by the first groove.

### BACKGROUND OF THE INVENTION

1. Field of the Invention

The present invention relates to an optical module for optically coupling a photo receiver, such as a PD (photo diode), to an optical fiber by using an optical bench, and a method of producing the optical module.

2. Description of the Prior Art

An SMT (Surface Mount Technology) optical module with a low price is needed in a subscriber unit or the like for use in an optical fiber communication system. To assemble such an optical module, a low-cost method (passive alignment) of, by using an optical bench in which a V-shaped groove for positioning an optical fiber and an alignment mark used for positioning a photo receiver to be mounted are machined on a silicon substrate with a high degree of accuracy, positioning the photo receiver with a high degree of accuracy without adjusting the optical axis of the optical fiber (active alignment), and mounting both the photo receiver and the optical fiber without any other adjustment is implemented.

FIG. 14 is a perspective view showing the structure of an optical bench, as disclosed in Japanese patent application publication (TOKKAIHEI) No. 11-23913, for use in a prior art optical module, on which a photo receiver and an optical fiber are to be aligned with a high degree of accuracy through passive alignment. FIG. 15 is a perspective view showing the prior art optical module in which a photo receiver and an optical fiber are mounted. In these figures, reference numeral 50 denotes an optical bench, reference numeral 51 denotes a first groove formed in an upper surface of the optical bench 50 and having a V-shaped cross section, for positioning the optical fiber 53, and reference numeral 52 denotes a second groove connected to the first groove 51 and extending from the upper surface of the optical bench to a side surface of the optical bench, for mounting the photo receiver 54. The second groove 52 forms a slope 55 to which the photo receiver 54 is to be secured. FIGS. 16(a) and 16(b) are side and plan views showing an example of use of the prior art optical module as shown in FIGS. 14 and 15. In these figures, reference numeral 56 denotes a preamplifier for amplifying an output of the photo receiver 54, reference numeral 57 denotes a bonding pad disposed on the preamplifier 56, and reference numeral 58 denotes a wire for electrically connecting an electrode of the photo receiver 54 to the bonding pad 57.

Alignment of the photo receiver 54 fixed to the slope 55 of the optical module shown in FIG. 15 with the optical fiber 53 mounted in the first groove 51 depends on the accuracy of mounting of the photo receiver 54 on the optical bench 50. Since the slope 55 in the second groove 52 is so machined as to have a bottom edge whose length is equal to that of a corresponding side of the photo receiver 54, the mounting accuracy is determined by the accuracy of finishing of the second groove 52 and the accuracy of forming of the photo receiver 54 and is about ±1 micrometer. The above-mentioned Japanese patent application publication (TOKKAIHEI) No. 11-23913 further discloses a method of positioning the photo receiver 54 on the optical bench 50 by using an alignment pattern (i.e., mark), which is not illustrated in FIGS. 14 and 15. The reference says that this method also provides an accuracy of submicrometer order.

As shown in FIG. 16(a), since one surface of the photo receiver 54 to which the wire 58 is connected is sloped, a special wire-bonding apparatus for tilting the sub-assembly so that the surface of the photo receiver 54 is placed in a horizontal position is required to bond the wire 58 to the surface of the photo receiver 54.

FIG. 17 is a perspective view showing the structure of optical coupling components of another prior art optical module, and FIG. 18 is a partially sectional view showing a package of the optical module in which the optical coupling components shown in FIG. 17 are mounted. In these figures, reference numeral 40 denotes a photo receiver, such as a PD, having a receiving surface 42, reference numeral 41 denotes a photo receiver positioning member having a side surface to which the photo receiver 40 is secured, reference numeral 43 denotes an optical bench constructed of a silicon substrate, reference numeral 45 denotes a mark formed on an upper surface of the optical bench 43, for alignment of the photo receiver positioning member, and reference numeral 47 denotes a groove formed in the upper surface of the optical bench 43 and having a V-shaped cross section, for positioning an optical fiber 46.

Next, a method of producing a prior art optical module having the optical coupling components shown in FIG. 17 will be explained. First of all, the photo receiver 40 is bonded to one side surface of the photo receiver positioning member 41. At this time, the photo receiver 40 is positioned on the above-mentioned side surface of the photo receiver positioning member 41 based on the outside shape of the photo receiver positioning member 41. Although FIG. 17 shows that the photo receiver positioning member 41 has right-angled edges, it has actually curved edges with a given radius of curvature R and therefore the outside shape of the photo receiver positioning member 41 cannot be clearly recognized. Therefore, an error is caused in the alignment of the photo receiver 40, and the alignment accuracy is ±10 micrometers in both the horizontal direction (i.e., the direction of x-axis of FIG. 17) and the direction of height (i.e., the direction of y-axis of FIG. 17).

On the other hand, the groove 47 for positioning the optical fiber 46 and the two marks 45 for alignment of the photo receiver positioning member are formed on the optical bench 43, as previously mentioned. Since the groove 47 and the two marks 45 for alignment of the photo receiver positioning member are produced with a high degree of accuracy through photoengraving, the groove 47 is in proper alignment with the two marks 45.

After the photo receiver 40 is bonded to the photo receiver positioning member 41, the optical bench 43 is mounted in the package 48. An image of the upper surface of the optical bench 43 containing the two marks 45 for alignment of the photo receiver positioning member is then seen by a camera not shown in the figure. The acquired image is subjected to image processing and the two marks 45 for alignment of the photo receiver positioning member are recognized through image recognition. Next, the photo receiver positioning member 41 is aligned only with respect to the directions of x-axis and z-axis of FIG. 17 so that the center of the receiving surface 42 of the photo receiver 40 is on the optical axis of the optical fiber 46 based on the recognized two marks 45 for alignment of the photo receiver positioning member, and the photo receiver positioning member 41 is mounted in the package 48. At this time, since the alignment is performed based on the outside shape of the photo receiver positioning member 41, an error is caused in the alignment of the photo receiver positioning member 41 with the optical bench 43 and the alignment accuracy with respect to the horizontal direction (i.e., direction of x-axis) is ±10 micrometers.

As a result, an error that occurs in the alignment of the center of the receiving surface 42 of the photo receiver 40 with the optical axis of the optical fiber 46 is given as follows. As for the horizontal direction (i.e., direction of x-axis of FIG. 17), there causes a total error of about ±20 micrometer which is the sum of an error of ±10 micrometers which occurs when bonding the photo receiver 40 to the photo receiver positioning member 41 and an error of ±10 micrometers which occurs when mounting the photo receiver positioning members 41 in the package 48. On the other hand, as for the direction of height (i.e., direction of y-axis of FIG. 17), there causes a total error of about ±30 micrometer which is the sum of an error of ±10 micrometers which occurs when bonding the photo receiver 40 to the photo receiver positioning member 41 and a variation of ±20 micrometers in the direction of height of the optical axis of the optical fiber 46 due to variations in the thickness of the optical bench 43 for holding the optical fiber 46.

FIG. 19 is a partially sectional view showing the structure of another prior art optical module as disclosed in Japanese patent application publication (TOKKAISHO) No. 63-15478, and FIG. 20 is a perspective view of a stem equipped with a V block and a fiber securing block for use in the prior art optical module shown in FIG. 19. In these figures, reference numeral 60 denotes a photo receiver, reference numeral 61 denotes a photo receiver mounting stem, reference numeral 62 denotes the stem equipped with a V block and a fiber securing block for securing an optical fiber 66, reference numeral 67 denotes a groove formed in an upper surface of the stem 62 and having a V-shaped cross section, for securing the optical fiber 66, reference numeral 68 denotes a package, and reference numeral 69 denotes a solder for securing the optical fiber in the groove.

In the prior art optical module shown in FIGS. 19 and 20, the photo receiver mounting stem 61 is mounted on the stem 62 equipped with a V block and a fiber securing block, for securing the optical fiber 66. However, details of any alignment method of aligning the photo receiver 60 and the optical fiber 66 are not disclosed in the above-mentioned reference. While the above-mentioned reference discloses the mounting of the photo receiver mounting stem 61 on the stem 62 equipped with a V block and a fiber securing block, it does not disclose any alignment method to correct an error caused in the distance from the surface of the stem 62 on which the photo receiver mounting stem 61 is mounted to the groove 67, and an error in the height of the photo receiver 60 when bonding the photo receiver 60 to the photo receiver mounting stem 61.

FIG. 21 is a partially sectional view showing the structure of a prior art optical module of coaxial type assembled through active alignment. In the figure, reference numeral 70 denotes a photo receiver package, reference numeral 71 denotes a photo receiver, such as a PD, having a receiving surface 72, reference numeral 73 denotes a submount to which the photo receiver 71 is secured, reference numeral 74 denotes a glass window mounted in a surface of the photo receiver package, upon which light is incident, reference numeral 80 denotes a lens holder, reference numeral 81 denotes a lens, such as a spherical lens, held by the lens holder 80, reference numeral 90 denotes an optical fiber positioning member for positioning an optical fiber end portion 91, reference numeral 92 denotes an optical fiber, reference numeral 93 denotes a rubber holder, and reference numeral 100 denotes a housing for housing this optical module.

When assembling the prior art optical module shown in FIG. 21, the optical fiber positioning member 90 and the lens holder 80 are coupled to each other first. By launching light into an end (not shown in the figure) of the optical fiber 92, and further launching the light emitted out the other end of the optical fiber into the receiving surface 72 of the photo receiver 71, the combination of the optical fiber positioning member 90 and the lens holder 80 is made to be in alignment with the photo receiver package 70. In this case, an output of the photo receiver 71 is monitored and the combination of the optical fiber positioning member 90 and the lens holder 80 is aligned so that the output is maximized.

A problem with a prior art optical module assembled through passive alignment as mentioned above is that a large error occurs in the alignment of the center of the receiving surface of a photo receiver with the optical axis of an optical fiber when assembling the optical module. Particularly, in the prior art optical module shown in FIGS. 17 and 18, there causes an error of about ±20 micrometer as for the horizontal direction and an error of about ±30 micrometer as for the direction of height. For example, when an optical fiber having a core of a diameter of 10 micrometers is combined with a photo receiver having a receiving diameter of 50 micrometers so as to establish photo coupling between them, the tolerance of alignment of the optical axis of the optical fiber in both the vertical and horizontal directions is about ±20 micrometers. Therefore, there is a possibility that desired photo coupling is not established in the prior art optical module as shown in FIGS. 17 and 18 because the alignment accuracy exceeds the tolerance of alignment of the optical axis of the optical fiber.

Another problem is that in a fast-response and high-sensitivity optical module, since it is necessary to use a photo receiver having a receiving diameter of about 20 micrometers, it is difficult to implement desired photo coupling with the alignment accuracy which can be achieved in a prior art optical module as mentioned above. The reason for the necessity of a photo receiver with a smaller receiving diameter is an increase in the capacity of the photo receiver caused by an increase in the receiving diameter of the photo receiver, and hence limitations imposed on the quick response and an increase in noise. In the case of an optical fiber having a receiving diameter of 20 micrometers, the tolerance of alignment of the optical axis of the optical fiber is about ±5 micrometers. It is therefore impossible to achieve such alignment accuracy since the prior art optical module has a large error structurally.

Furthermore, in the prior art optical module as shown in FIGS. 14 to 16, since the alignment accuracy with which to secure the photo receiver 54 to the slope 55 of the mounting groove 52 depends on the accuracy of finishing of the second groove 52 and the accuracy of forming of the photo receiver 54, or an image of an alignment pattern (i.e., mark) not shown in the figures is recognized so as to align the photo receiver 54, high alignment accuracy is provided. A problem is however that since the photo receiver 54 is sloped, a special wire-bonding apparatus for placing the sloped surface of the photo receiver 54 in a horizontal position and boding a wire 58 to the sloped surface. A further problem is that it is necessary to pre-mount solder on a side surface of the photo receiver 54 that is to be fixed to the slope 55 to bond the photo receiver 54 to the slope 55.

In a prior art optical module of coaxial type, as shown in FIG. 21, assembled through active alignment, since light is actually launched into a receiving surface 72 of a photo receiver 71 and an integrated combination of an optical fiber positioning member 90 and a lens holder 80 is placed in alignment with a photo receiver package 70 so that an output of the photo receiver 71 is maximized, a higher degree of alignment accuracy is provided as compared with above-mentioned prior art optical modules assembled through passive alignment, but miniaturization of the prior art optical module of coaxial type is difficult and the manufacturing cost is high because the following plurality of components: the photo receiver package 70, the lens holder 80, and the optical fiber positioning member 90 are aligned after they are assembled, respectively. A further problem is that since the prior art optical module of coaxial type has a cylindrical geometry, it is difficult to surface-mount the optical module.

Furthermore, although the prior art optical module shown in FIGS. 17 and 18 can be assembled through active alignment without having to provide two marks 45 for alignment, it is necessary to perform active alignment when mounting a photo receiver positioning member 41 and an optical bench 43 in a package 48. A problem with the prior art optical module shown in FIGS. 17 and 18 is therefore that while proper alignment is performed as for the direction of x-axis of FIG. 17, an error of about ±20 micrometers occurs in the alignment in the direction of y-axis due to variations in the thickness of the optical bench 43. Since the alignment accuracy in the direction of y-axis is thus low and it is difficult to also perform active alignment in the direction of y-axis, the prior art optical module shown in FIGS. 17 and 18 is usually assembled through passive alignment.

### SUMMARY OF THE INVENTION

The present invention is proposed to solve the above-mentioned problems, and it is therefore an object of the present invention to provide an optical module which can be assembled with a high degree of accuracy through passive alignment, which can be applied to a photo receiver with a small receiving diameter, and which has a structure that facilitates surface mounting, and a method of producing the optical module.

It is another object of the present invention to provide an optical module which can be assembled with a high degree of accuracy through active alignment, which can be applied to a photo receiver with a small receiving diameter, and which has a structure that facilitates surface mounting, and a method of producing the optical module.

In accordance with an aspect of the present invention, there is provided an optical module comprising: a photo receiver having a receiving surface; a first positioning member having a side surface to which the photo receiver is secured; and a second positioning member having a first groove formed in an upper surface thereof for positioning an optical fiber, and a second groove formed in the upper surface thereof, the second groove extending from a side surface of the second positioning member to the first groove and being connected to the first groove, the photo receiver having partially housed in the second groove, and the side surface of the first positioning member being secured to the side surface of the second positioning member.

In accordance with another aspect of the present invention, the second positioning member includes a position indicator for substantially indicating a position of a center of a light spot which is to be produced on the receiving surface of the photo receiver by light emitted out of an end of the optical fiber positioned by the first groove.

In accordance with a further aspect of the present invention, the position indicator of the second positioning member has two marks for substantially indicating an intersection where an optical axis of the optical fiber intersects with a plane including the side surface of the second positioning member.

In accordance with another aspect of the present invention, the two marks are two grooves formed in the upper surface of the second positioning member on both sides of the first groove so that they are running at an equal distance from the first groove, the two grooves extending from the side surface of the second positioning member and being identical in cross-sectional shape.

In accordance with a further aspect of the present invention, the two grooves are V-shaped in cross section.

In accordance with another aspect of the present invention, the photo receiver has a position indicator for indicating a center of the receiving surface.

In accordance with a further aspect of the present invention, the position indicator of the photo receiver is two marks disposed in the vicinity of the receiving surface.

In accordance with another aspect of the present invention, the first groove is sloped relative to the side surface of the second positioning member to which the side surface of the first positioning member is secured.

In accordance with a further aspect of the present invention, the first positioning member is so sized that a bottom surface thereof perpendicular to the side surface thereof to which the photo receiver is secured is higher than a bottom surface of the second positioning member which is opposite to the upper surface of the second positioning member in which the first groove is formed.

In accordance with another aspect of the present invention, the second positioning member is constructed of a silicon substrate.

In accordance with a further aspect of the present invention, a part of the side surface of the first positioning member is bonded to the side surface of the second positioning member with an adhesive.

In accordance with another aspect of the present invention, the optical module further comprises a package having an inner wall to which a bottom surface of the second positioning member and a bottom surface of the first positioning member are bonded, for housing the first and second positioning members.

In accordance with a further aspect of the present invention, there is provided a method of producing an optical module, comprising the steps of: securing a photo receiver to a side surface of a first positioning member; measuring a position of a receiving surface of the photo receiver secured to the first positioning member; substantially measuring a position of a center of a light spot which is to be produced on the receiving surface of the photo receiver by light emitted out of an end of an optical fiber to be positioned by a first groove formed in an upper surface of a second positioning member; based on the measured position of the receiving surface of the photo receiver and the measured position of the center of the light spot, aligning the first positioning member and the second positioning member with each other; and securing the side surface of the first positioning member and a side surface of the second positioning member to each other after the aligning step is completed.

In accordance with another aspect of the present invention, the light spot position measuring step is the step of substantially measuring the position of the center of the light spot by using a position indicator formed in the second positioning member, for substantially indicating the position of the center of the light spot which is to be produced on the receiving surface of the photo receiver by light emitted out of an end of an optical fiber to be positioned by the first groove.

In accordance with a further aspect of the present invention, the position indicator has two marks for substantially indicating an intersection where an optical axis of the optical fiber intersects with a plane including the side surface of the second positioning member.

In accordance with another aspect of the present invention, the two marks are two grooves formed in the upper surface of the second positioning member on both sides of the first groove so that they are running at an equal distance from the first groove, the two grooves extending from the side surface of the second positioning member and being identical in cross-sectional shape.

In accordance with a further aspect of the present invention, the light spot position measuring step is the step of producing an image of the two marks, performing image processing on the produced image so as to measure positions of the two marks, and determining the position of the center of the light spot based on a position of a midpoint between the measured positions of the two marks.

In accordance with another aspect of the present invention, the receiving surface position measuring step is the step of measuring the position of the receiving surface based on a shape of the receiving surface of the photo receiver.

In accordance with a further aspect of the present invention, the receiving surface position measuring step is the step of producing an image of the photo receiver, recognizing the shape of the receiving surface by performing image processing on the produced image, and setting a centroid of the shape to be the position of the receiving surface.

In accordance with another aspect of the present invention, the receiving surface position measuring step is the step of measuring the position of the receiving surface by measuring positions of two marks formed on the photo receiver in advance.

In accordance with a further aspect of the present invention, the receiving surface position measuring step is the step of measuring the positions of the two marks by producing an image of the two marks and performing image processing on the produced image.

In accordance with another aspect of the present invention, the securing step is the step of securing a part of the side surface of the first positioning member and the side surface of the second positioning member to each other by bonding the part of the side surface of the first positioning member to the side surface of the second positioning member.

In accordance with an aspect of the present invention, there is provided a method of producing an optical module, comprising the steps of: securing a photo receiver to a first positioning member; placing an optical fiber in a groove formed in an upper surface of a second positioning member and connecting a laser light source to an end of the optical fiber; aligning the first positioning member and the second positioning member with each other so that laser light emitted out of the laser light source and then output from another end of the optical fiber is optimally incident upon the photo receiver; and securing the aligned first and second positioning members to each other after the aligning step is completed.

In accordance with an aspect of the present invention, there is provided a method of producing an optical module, comprising the steps of: securing a photo diode to a first positioning member; placing an optical fiber in a groove formed in an upper surface of a second positioning member and connecting an optical receiver that outputs a signal corresponding to light received to an end of the optical fiber; causing the photo diode to emit light by applying a forward voltage to the photo diode; aligning the first positioning member and the second positioning member with each other so that the light emitted out of the photo diode is incident upon another end of the optical fiber, and further aligning the first positioning member and the second positioning member with each other according to a signal output from the optical receiver; and securing the aligned first and second positioning members to each other after the aligning step is completed.

Further objects and advantages of the present invention will be apparent from the following description of the preferred embodiments of the invention as illustrated in the accompanying drawings.

### BRIEF DESCRIPTION OF THE DRAWINGS

FIG. 1 is a perspective view showing a sub-assembly that consists of optical coupling components of an optical module according to a first embodiment of the present invention;

FIG. 2 is a plan view of the sub-assembly of the optical module according to the first embodiment of the present invention shown in FIG. 1;

FIG. 3 is a cross-sectional view taken along the line A-A of FIG. 2 of the sub-assembly of the optical module according to the first embodiment of the present invention;

FIG. 4 is a perspective view showing an optical bench of the sub-assembly of the optical module according to the first embodiment of the present invention shown in FIG. 1;

FIG. 5 is a plan view showing a side surface of the optical bench shown in FIG. 4 to which a photo receiver positioning member is secured;

FIG. 6 is a partially sectional view showing the sub-assembly of FIG. 1 mounted in a package in the optical module according to the first embodiment of the present invention;

FIG. 7 is a schematic diagram showing a method of producing an optical module according to the first embodiment of the present invention;

FIG. 8 is a plan view showing the photo receiver positioning member of the optical module according to the first embodiment of the present invention;

FIG. 9(a) is a plan view showing a photo receiver positioning member of an optical module according to a variant of the first embodiment of the present invention;

FIG. 9(b) is a plan view showing a photo receiver positioning member of an optical module according to another variant of the first embodiment of the present invention;

FIGS. 10(a) to (c) are slide, plan, and perspective views showing an example of use of the optical module according to the first embodiment of the present invention;

FIG. 11 is a perspective view showing a sub-assembly that consists of optical coupling components of an optical module according to a second embodiment of the present invention;

FIG. 12 is a schematic diagram showing a method of producing an optical module according to the second embodiment of the present invention;

FIG. 13 is a schematic diagram showing a method of producing an optical module according to a variant of the second embodiment of the present invention;

FIG. 14 is a perspective view showing an optical bench for use with a prior art optical module;

FIG. 15 is a perspective view showing the optical module in which a photo receiver and an optical fiber are mounted on the optical bench shown in FIG. 14;

FIGS. 16(a) and 16(b) are side and plan views showing an example of use of the prior art optical module shown in FIGS. 14 and 15;

FIG. 17 is a perspective view showing the structure of optical coupling components of a prior art optical module;

FIG. 18 is a partially sectional view showing the prior art optical module in which the optical coupling components shown in FIG. 17 are mounted in a package;

FIG. 19 is a partially sectional view showing the structure of another prior art optical module;

FIG. 20 is a perspective view showing the structure of a stem equipped with a V block and a fiber securing block for use with the prior art optical module shown in FIG. 19; and

FIG. 21 is a partially sectional view showing the structure of another prior art optical module.

### DETAILED DESCRIPTION OF THE PREFERRED EMBODIMENTS

Embodiment 1.

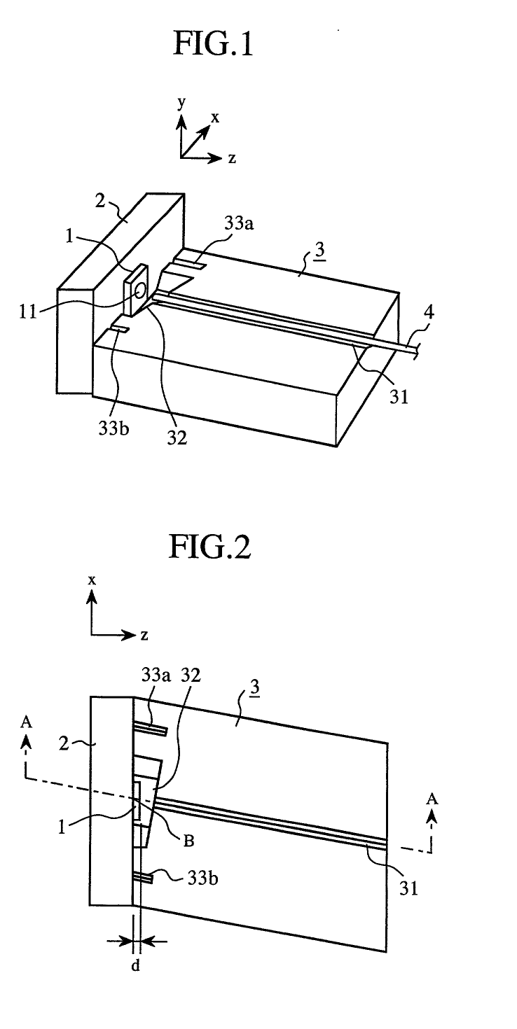

FIG. 1 is a perspective view showing a sub-assembly that consists of optical coupling components of an optical module according to a first embodiment of the present invention, FIG. 2 is a plan view of the sub-assembly shown in FIG. 1, and FIG. 3 is a cross-sectional view of the sub-assembly taken along the line A-A of FIG. 2. In these figures, reference numeral 1 denotes a photo receiver such as a PD, reference numeral 2 denotes a photo receiver positioning member (first positioning member) having a side surface to which the photo receiver 1 is secured, and reference numeral 3 denotes an optical bench (second positioning member) constructed of a silicon substrate and having a side surface (referred to as bonding surface from here on) bonded to a part of the side surface of the photo receiver positioning member 2, for positioning an optical fiber 4. Furthermore, reference numeral 11 denotes a receiving surface of the photo receiver 1, reference numeral 31 denotes a first groove formed in an upper surface of the optical bench 3 and having a V-shaped cross section, for positioning the optical fiber 4, reference numeral 32 denotes a second groove formed in the upper surface of the optical bench 3 like the first groove 31 and extending from the bonding surface to the first groove 31, the second groove being connected to the first groove 31, for housing the photo receiver 1 fixed to the photo receiver positioning member 2 so that the photo receiver 1 is not in contact with the above-mentioned side surface of the optical bench 3, and reference numerals 33a and 33b denote third and fourth grooves (position indicator) formed in the upper surface of the optical bench 3, for substantially indicating a position of a center of a light spot (simply referred to as spot center position from here on) which is to be produced on the receiving surface 11 of the photo receiver 1 by light emitted out of an end of the optical fiber 4 positioned by the first groove 31, the third and fourth grooves 33a 33b being of identical V-shaped cross sectional shape.

The receiving surface 11 of the photo receiver 1 has such a shape as a circle as shown in FIG. 1 and is flush with the side surface of the photo receiver 1. The receiving surface 11 is coated with a nonreflective material, and the side surface of the photo receiver 1 except the receiving surface 11 is metalized so that no light is incident upon an electrode of the photo receiver 1 and so on. The receiving surface 11 typically has such a shape as a circle or a square which is symmetric with respect to the horizontal and vertical lines. However, the receiving surface 11 can have any shape other than such a shape as a circle or a square which is symmetric with respect to the horizontal and vertical lines.

As shown in FIG. 2, the first groove 31 formed in the upper surface of the optical bench 3 is disposed so that it is not perpendicular to but sloped relative to the bonding surface of the optical bench 3. Therefore, since the receiving surface 11 of the photo receiver 1 is parallel to the side surface of the photo receiver positioning member 2 bonded to the bonding surface of the optical bench 3, the optical axis of the optical fiber 4 positioned by the first groove 31 is not perpendicular to but sloped relative to the receiving surface 11 of the photo receiver 1. In general, in an optical module which contains a PD or the like, to prevent light, which has been emitted out an optical fiber and has been incident on and reflected from the receiving surface of the PD, from optically coupling to the optical fiber again and returning through the optical fiber, the optical fiber is arranged so that the optical axis of the optical fiber is not perpendicular to but sloped relative to the receiving surface of the PD. In contrast, in accordance with the first embodiment of the present invention, since the first groove 31 for positioning the optical fiber 4 is so formed that it is sloped relative to the bonding surface of the optical bench 3, when the photo receiver positioning member 2 to which the photo receiver 1, such as a PD, is secured is bonded to the bonding surface of the optical bench 3, the optical fiber 4 will be automatically arranged so that its optical axis is accurately sloped relative to the receiving surface 11 of the photo receiver 1 at a certain angle.

As shown in FIGS. 1 and 2, the third and fourth grooves 33a and 33b are formed in the upper surface of the optical bench 3 on both sides of the first groove 31 so that they are running at an equal distance from the first groove 31, and are extending from the bonding surface of the optical bench 3. Since the third and fourth grooves 33a and 33b are formed through photoengraving and etching at the same time that the first groove 31 for positioning the optical fiber 4 is formed, the alignment of the third and fourth grooves 33a and 33b with the optical fiber 4 mounted in the first groove 31 is determined with a high degree of accuracy. In other words, the optical axis of the optical fiber 4 mounted in the first groove 31 agrees with a straight line at an equal distance from the third and fourth grooves 33a and 33b, and the straight line is located above the upper surface of the optical bench 3 only by a distance determined by the angle between the two slopes forming the first groove 31, the width of the first groove 31, and the diameter of the optical fiber 4. For example, the optical axis of the optical fiber 4 agrees with a straight line at an equal distance from the third and fourth grooves 33a and 33b, which is away from the upper surface of the optical bench 3 by about 10 micrometers in a positive direction of y-axis.

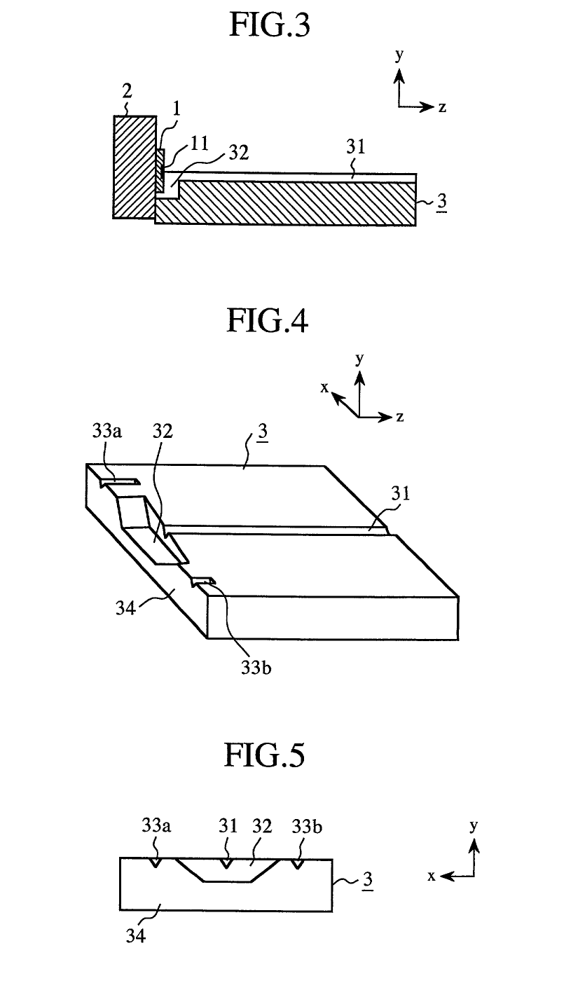

FIG. 4 is a perspective view of the optical bench 3 when viewed from the bonding surface of the optical bench 3, and FIG. 5 is a plan view showing the bonding surface of the optical bench 3. In these figures, reference numeral 34 denotes the bonding surface (one side surface) of the optical bench 3 which is bonded to one side surface of the photo receiver positioning member 2. As can be seen from FIGS. 4 and 5, the third and fourth grooves 33a and 33b have end portions on the bonding surface 34 that are 2-equal size triangles whose vertexes correspond to the valleys of the third and fourth grooves, respectively. The midpoint of a straight-line segment that connects vertexes (or centroids) of the end portions (i.e., 2-equal size triangles) of the third and fourth grooves 33a and 33b agrees with a vertex (or centroid) of an end portion of the first groove 31 on the bonding surface 34. The midpoint of the straight-line segment that connects the vertexes (or centroids) of the end portions of the third and fourth grooves 33a and 33b does not have to completely agree with the vertex (or centroid) of the end portion of the first groove 31. In other words, the x coordinate of the above-mentioned midpoint only has to agree with the x coordinate of the vertex (or centroid) of the end portion of the first groove 31. Therefore, when assembling the sub-assembly as shown in FIGS. 1 to 3, by measuring the position (x coordinate) of the midpoint of the straight-line segment that connects the vertexes (or centroid) of the end portions of the third and fourth grooves 33a and 33b on the bonding surface 34, the position (x and y coordinates) of an intersection (B of FIG. 2) where the optical axis of the optical fiber 4 positioned by the first groove 31 intersects with a plane including the-bonding surface 34 of the optical bench 3, i.e., the spot center position (x and y coordinates) can be obtained. As previously mentioned, the position of the midpoint of the straight-line segment that connects the vertexes (or centroids) of the end portions of the third and fourth grooves 33a and 33b does not completely match with the position of the intersection where the optical axis of the optical fiber 4 positioned by the first groove 31 intersects with a plane including the bonding surface 34 of the optical bench 3. The y coordinate of this intersection is away from the upper surface of the optical bench 3 in the positive direction of the y-axis only by a distance determined by the angle between the two slopes forming the first groove 31, the width of the first groove 31, and the diameter of the optical fiber 4 (therefore, if the y coordinate of the upper surface of the optical bench 3 is determined, the y coordinate of the above-mentioned intersection is determined). In addition, as shown in FIGS. 2 and 3, since the first groove 31 for positioning the optical fiber 4 is sloped relative to the bonding surface 34 of the optical bench 3, and the receiving surface 11 of the photo receiver 1 is not flush with the bonding surface 34, the position of the intersection B shown in FIG. 2 does not completely match with the spot center position. As can be seen from FIG. 2, the spot center position is shifted from the position of the intersection B in a negative direction of the x-axis only by a distance determined by the angle of inclination of the first groove 31 relative to the bonding surface 34, and the distance d between the receiving surface 11 and the bonding surface 34, i.e., the thickness of the photo receiver 1.

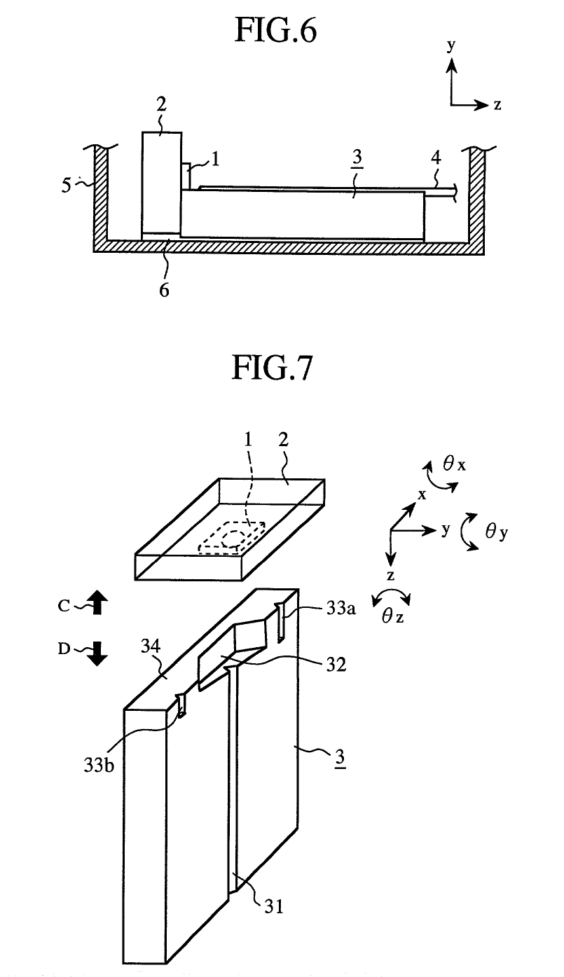

FIG. 6 is a partially sectional view showing a package of the optical module according to the first embodiment of the present invention in which the sub-assembly that consists of the optical coupling components as shown in FIGS. 1 to 3 is disposed. In the figure, reference numeral 5 denotes the package having an inner wall to which the bottom of the combination of the optical coupling components is bonded, and reference numeral 6 denotes an adhesive for bonding the bottom of the combination of the optical coupling components to the inner wall of the package 5. As shown in FIG. 6, the bottom surface of the photo receiver positioning member 2 which is a rectangular parallelepiped, which is perpendicular to the side surface to which the photo receiver 1 is secured, is located at a higher position than the bottom surface of the optical bench 3. This is because it is difficult to make the bottom surface of the photo receiver positioning member 2 be completely flush with the bottom surface of the optical bench 3 because the sub-assembly is assembled by positioning and bonding the photo receiver positioning member 2 and the optical bench 3 with each other, as described later. Furthermore, since the bottom surface of the optical bench 3 mainly occupies the bottom of the sub-assembly, it is preferable that the size and shape of the photo receiver positioning member 2, which is a rectangular parallelepiped, is predetermined so that the bottom surface of the optical bench 3 which mainly occupies the bottom of the sub-assembly is located below the bottom surface of the photo receiver positioning member 2 when assembling the sub-assembly. As a result, the sub-assembly can be horizontally located with stability on the inner wall of the package 5 to which the sub-assembly should be secured. To secure the sub-assembly to the inner wall of the package 5, not only the bottom surface of the optical bench 3 but also the bottom surface of the photo receiver positioning member 2 are bonded to the inner wall of the package 5 with the adhesive 6. As a result, a big bonding area can be ensured and therefore sufficient adhesion can be provided.

Next, a description will be made as to a method of producing an optical module according to the first embodiment of the present invention. In accordance with the method of producing an optical module according to the first embodiment, the photo receiver 1 having the receiving surface 11 is bonded to a suitable position of one side surface of the photo receiver positioning member 2 with solder or the like while positioning the photo receiver 1 relative to the photo receiver positioning member 2 (photo receiver securing step).

Next, before bonding a part of the side surface of the photo receiver positioning member 2 to which the photo receiver 1 is secured to the bonding surface 34 of the optical bench 3 formed as shown in FIGS. 1 to 5 with an adhesive such as a resin bond, measurement of the position of the receiving surface 11 of the photo receiver 1 secured to the photo receiver positioning member 2 (receiving surface position measurement step) and measurement of the spot center position (spot position measurement step) are performed. Alignment of the photo receiver positioning member 2 with the optical bench 3 (alignment step) is performed based on the measured position (for example, centroid) of the receiving surface 11 and the measured spot center position.

FIG. 7 is a diagram schematically showing the receiving surface position measurement step, the spot position measurement step, and the alignment step of the method of producing an optical module according to the first embodiment. These steps will be explained hereafter with reference to this drawing. First of all, the photo receiver positioning member 2, to which the photo receiver 1 is bonded, is fixed to an arm (not shown in the figure) secured to a movement stage (also not shown in the figure) which can be moved on four axes (x, y, z, and θz) with its side surface to which the photo receiver 1 is bonded being oriented downwardly in the figure. At this time, it is assumed that the side surface of the photo receiver positioning member 2 which is a rectangular parallelepiped, to which the photo receiver 1 is bonded, is parallel to an xy plane. In other words, it is assumed that the photo receiver positioning member 2 has already been aligned so that the above-mentioned side surface thereof becomes parallel with the xy plane.

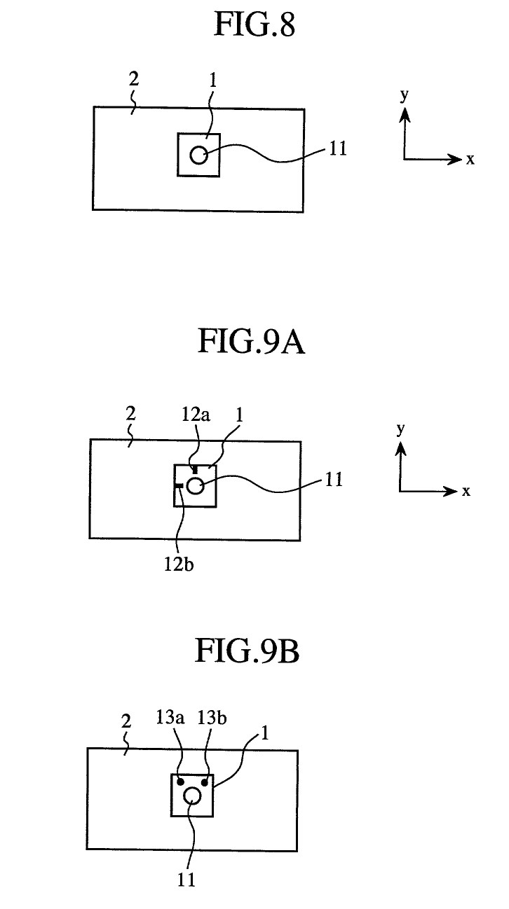

A camera (not shown in the figure) is located below the receiving surface 11 of the photo receiver 1 and between the optical bench 3 and the photo receiver positioning member 2, and an image of the photo receiver 11 that contains the receiving surface 11 is taken with this camera. FIG. 8 is a plan view showing the side surface of the photo receiver positioning member 2 to which the photo receiver 1 is bonded, an image of the side surface being taken from the arrow of C of FIG. 7 with the camera. An information processing device not shown in the figure, such as a computer, performs image processing, such as edge extraction processing and binarization processing, on the image of the photo receiver 1, which is taken with the camera, so as to produce a binary gray scale image, and then recognizes the shape of the receiving surface 11 of the photo receiver 1 based on the binary gray scale image. The information processing device then calculates the centroid position (the center in the case where the receiving surface 11 is a circle) of the shape of the recognized receiving surface 11, and determines the centroid position as the position (x1,y1) of the receiving surface 11 of the photo receiver 1. The information processing device stores this measured position (x1,y1) of the receiving surface 11 of the photo receiver 1 in a memory not shown in the figure.

Instead of measuring the position of the receiving surface 11 by processing an image of the photo receiver 1 which is taken with a camera, the position of the receiving surface 11 can be measured by using two marks which are formed on the surface of the photo receiver 1 through photoengraving. In this case, the position of the receiving surface 11 is determined by taking an image of the two marks with a camera and processing the acquired image.

FIGS. 9(a) and (b) are plan views showing such variants. In those figures, the side surface with two marks of the photo receiver positioning member 2, to which the photo receiver 11 is secured and which is seen from the arrow C of FIG. 7 by a camera to produce an image is shown. In FIG. 9(a), reference numerals 12a and 12b denote marks (position indicator) formed in the vicinity of the receiving surface 11 of the photo receiver 1, respectively. The mark 12a is a mark used to indicate a position x1 of the receiving surface 11 in the direction of x-axis, and the mark 12b is a mark used to indicate a position y1 of the receiving surface 11 in the direction of y-axis. These marks 12a and 12b are formed in advance on the surface of the photo receiver 1 through photoengraving so that they indicate the position (x1, y1) of the receiving surface 11 in cooperation with each other. The information processing device not shown in the figure, such as a computer, performs image processing, such as edge extraction processing and binarization processing, on the image of the photo receiver 1, which is seen by the camera, so as to produce a binary gray scale image, and then recognizes the two marks 12a and 12b based on the binary gray scale image. The information processing device then calculates the positions x1 and y1 of the recognized marks 12a and 12b, and determines these positions as the position (x1, y1) of the receiving surface 11 of the photo receiver 1. The information processing device stores this measured position (x1,y1) of the receiving surface 11 of the photo receiver 1 in a memory not shown in the figure. On the other hand, in FIG. 9(b), reference numerals 13a and 13b denote marks (position indicator) formed in the vicinity of the receiving surface 11 of the photo receiver 1, respectively. The mark 13a is a mark used to indicate a position (x2,y2), and the other mark 13b is a mark used to indicate another position (x3,y3). These marks 13a and 13b are formed in advance on the surface of the photo receiver 1 through photoengraving so that they indicate the position (x1,y1) of the receiving surface 11 in cooperation with each other. In the example shown in the figure, the midpoint ((x2+x3)/2, (y2+y3)/2) of a straight-line segment that connects the two marks 13a and 13b to each other has a fixed relationship with the position (x1,y1) of the receiving surface 11. When the photo receiver positioning member 2 is positioned with respect to θz so that y2 becomes equal to y3, the position (x1,y1) of the receiving surface 11 is given by the following equations: x1=(x2+x3)/2 and y1=y2−C, where C is a distance between the midpoint of the straight-line segment that connects the two marks 13a and 13b with each other and the position (x1,y1) of the receiving surface 11.

If the movement accuracy of the movement stage falls within an acceptable range, it is possible to move the arm, to which the photo receiver positioning member 2 is fixed, in a direction of xy or a direction of z, which is specified by a predetermined vector, after storing the position (x1, y1) of the receiving surface 11 of the photo receiver 1, to facilitate the following steps.

In accordance with the method of producing an optical module according to the first embodiment, by using the third and fourth grooves 33a and 33b formed on the optical bench 3, the spot position measurement step of measuring the spot center position is then performed. As shown in FIG. 7, the optical bench 3 is fixed to an arm (not shown in the figure) fixed to another movement stage (also not shown in the figure) which can be moved on the four axes (x, y, z, and θz) and which is different from the movement stage intended for the alignment of the photo receiver positioning member 2, with the bonding surface 34 being oriented upwardly in the figure. At this time, it is assumed that the bonding surface 34 of the optical bench 3 is parallel with the xy plane. In other words, it is assumed that the optical bench 3 has already been aligned so that the bonding surface 34 of the optical bench 3 becomes parallel with the xy plane.

A camera (not shown in the figure) is located above the optical bench 3 and between the optical bench 3 and the photo receiver positioning member 2, and an image of the bonding surface 34 of the optical bench 3 as shown in FIG. 5 is seen by this camera. The information processing device not shown in the figure, such as a computer, then performs image processing, such as edge extraction processing and binarization processing, on the image of the bonding surface 34 of the optical bench 3, which is seen by the camera, so as to produce a binary gray scale image, and then recognizes the end portions of the third and fourth grooves 33a and 33b of identical V-shaped cross-sectional shape and an edge of the upper surface of the optical bench 3 on which these grooves and the first groove 31 are formed from the binary gray scale image. As previously mentioned, the end portions of the third and fourth grooves 33a and 33b on the bonding surface 34 are 2-equal size triangles having vertexes corresponding to the valleys of the third and fourth grooves. So, the x coordinate of each of the end portions of the third and fourth grooves 33a and 33b can be determined by determining the x coordinate of the vertex of each end portion. As an alternative, by calculating the centroid of each above-mentioned 2-equal size triangle, the x coordinate of each of the end portions of the third and fourth grooves 33a and 33b can be determined.

As previously mentioned, since the third and fourth grooves 33a and 33b are formed through photoengraving and etching at the same time that the first groove 31 for positioning the optical fiber 4 is formed, the alignment of the third and fourth grooves 33a and 33b with the optical fiber 4 mounted in the first groove 31 is determined with a high degree of accuracy. On the other hand, the x coordinate of the spot center position does not completely match with the x coordinate of the midpoint of the straight-line segment that connects the vertexes (or centroids) of the end portions of the third and fourth grooves 33a and 33b on the bonding surface 34. As previously mentioned, the spot center position is shifted from the position of the intersection B in the negative direction of the x-axis only by a distance determined by the angle of inclination of the first groove 31 relative to the bonding surface 34, and the distance d between the receiving surface 11 and the bonding surface 34. The y coordinate of the spot center position is equal to the sum of the y coordinate of the upper surface of the optical bench 3 and the distance by which the optical axis of the optical fiber is away from the upper surface of the optical bench 3 and which is determined by the angle between the two slopes forming the first groove 31, the width of the first groove 31, and the diameter of the optical fiber 4. In the following, assume that the shifting of the x coordinate of the spot center position due to the inclination of the first groove 31 relative to the bonding surface 34 and the disagreement between the receiving surface 11 and the bonding surface 34 can be disregarded, and the optical axis of the optical fiber 4 is away from the upper surface of the optical bench 3 in the positive direction of y-axis by 10 micrometers. As an alternative, it is possible to calculate the shifting of the x coordinate of the spot center position which is determined by the angle of inclination of the first groove 31 relative to the bonding surface 34, and the distance d between the receiving surface 11 and the bonding surface 34, and to move the optical bench 3 to correct this shifting.

The optical bench 3 is then rotated with respect to the angle θz until the positions with respect to the direction of y-axis of the end portions of the third and fourth grooves 33a and 33b roughly become equal to each other so that the end portions of the third and fourth grooves 33a and 33b on the bonding surface 34 are aligned accurately in a straight line parallel to the x-axis. At this time, it is necessary to perform the rotation so that the photo receiver 11 is housed in the second groove 32 formed on the optical bench 3. The information processing device not shown in the figure, such as a computer, determines a position x21 of the third groove 33a with respect to the direction of x-axis and a position x22 of the fourth groove 33b with respect to the direction of x-axis based on the recognized shapes of the end portions of the third and fourth grooves 33a and 33b on the bonding surface 34, and calculates the midpoint between x21 and x22 and sets this midpoint to be x2. Furthermore, the information processing device determines a position yy of the recognized edge of the upper surface of the optical bench 3. As previously mentioned, since the optical axis of the optical fiber 4 is assumed to be away from the upper surface of the optical bench 3 in the positive direction of y-axis by 10 micrometers, the information processing device calculates y2 according to the following equation: y2=yy+10. Thus, the information processing device measures the spot center position (x2,y2). The information processing device then stores this measured spot center position (x2,y2) in a memory not shown in the figure.

Next, both the movement stage (not shown in the figure) to which the arm (not shown in the figure) for securing the photo receiver positioning member 2 is fixed and the other movement stage (not shown in the figure) to which the other arm (not shown in the figure) for securing the optical bench 3 is secured or either of them is moved so that the position (x1,y1) of the receiving surface 11 of the photo receiver 1 measured in the receiving surface position measurement step matches with the spot center position (x2,y2) measured in the spot position measurement step. After that, those movement stages are further moved so that they approach each other with respect to the direction of z-axis until the side surface of the photo receiver positioning member 2 to which the photo receiver 1 is secured touches the bonding surface of the optical bench 3. In addition, the movement stages are finely adjusted with respect to angles θx, θy, and θz, etc., and a part of the side surface of the photo receiver positioning member 2 to which the photo receiver 1 is secured is bonded to the bonding surface 34 of the optical bench 3 with an adhesive such as a resin bond.

In accordance with the method of producing an optical module according to the first embodiment, since an image of the photo receiver 1 is directly obtained and the position (e.g., centroid position) of the receiving surface 11 is measured through image recognition in the alignment step and the alignment of the photo receiver positioning member 2 with the optical bench 3 is performed based on the measured position of the receiving surface 11, as previously mentioned, an error which occurs when bonding the photo receiver 1 to the photo receiver positioning member 2 is not included in a final error, unlike a prior art production method of aligning the photo receiver positioning member based on its outside shape. In addition, since an image of the end portions on the bonding surface 34 of the third and fourth grooves 33a and 33b formed on the optical bench 3 is directly obtained and the spot center position is measured through image recognition, and the alignment of the photo receiver positioning member 2 with the optical bench 3 is performed based on the measured spot center position, so that the photo receiver positioning member 2 and the optical bench 3 are secured to each other, no error with respect to the direction of height (i.e., direction of y-axis) due to variations (±20 μm) in the thickness of the optical bench 3 is caused. Furthermore, after that, the sub-assembly that consists of the photo receiver positioning member 2 and the optical bench 3 which are secured to each other is mounted as a one-piece in the package 5, as shown in FIG. 6. At that time, since the alignment of the receiving surface 11 of the photo receiver 1 with the optical axis of the optical fiber 4 remains unchanged, the mounting of the sub-assembly in the package does not cause any error in the alignment.

As a result, the major portion of errors finally caused in the alignment of the receiving surface 11 of the photo receiver 1 with the optical axis of the optical fiber 4 in the optical module according to the first embodiment is errors to be caused in the positions of movement stages used in the alignment step for assembly of the optical module due to thermal deformation and so on. In general, when a high precision movement stage is used, an error caused by the movement stage falls within ±5 micrometers in both the horizontal direction (i.e., the direction of x-axis) and the direction of height (i.e., the direction of y-axis). Therefore, the first embodiment of the present invention offers an advantage of being able to provide an optical module in which the receiving surface 11 of the photo receiver 1 is in alignment with the optical axis of the optical fiber 4 with a higher degree of accuracy, as compared with the prior art optical module shown in FIGS. 14 and 15.

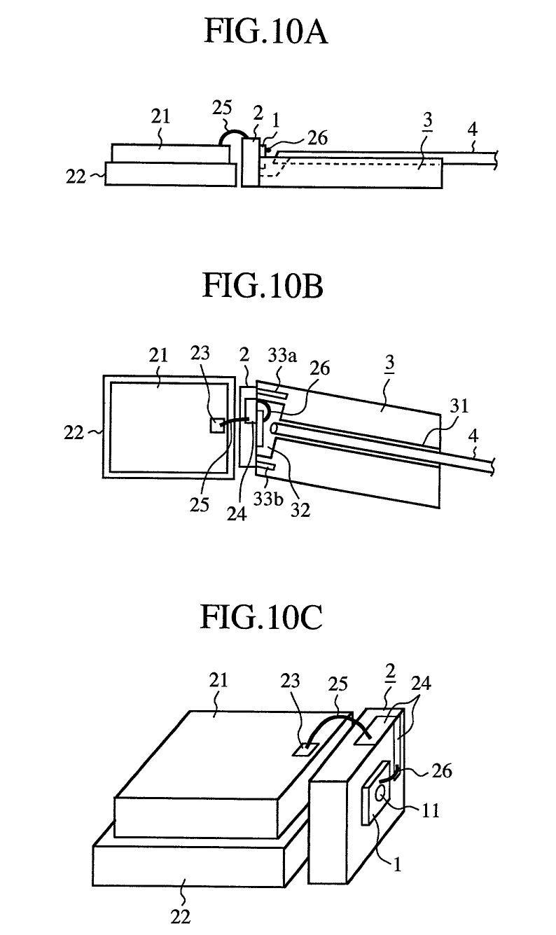

FIGS. 10(a) to 10(c) are side, plan, and perspective views showing an example of use of the optical module according to the first embodiment of the present invention. In the perspective view of FIG. 10(c), the optical bench 3 is not shown. In these figures, reference numeral 21 denotes a preamplifier for amplifying an output of the photo receiver 1, reference numeral 22 denotes a preamplifier circuit board on which the preamplifier 21 is mounted, reference numeral 23 denotes a bonding pad disposed on the preamplifier 21, for connection with the photo receiver 1, reference numeral 24 denotes wiring for connection with the photo receiver, which is formed on the photo receiver positioning member 2, reference numeral 25 denotes a wire for electrically connecting the bonding pad 23 to the wiring 24 for connection with the photo receiver, reference numeral 26 denotes a wire for electrically connecting the wiring 24 for connection with the photo receiver and the photo receiver 1. As shown in FIG. 10(c), the wiring 24 for connection with the photo receiver is formed so that it extends from the upper surface of the photo receiver positioning member 2 to the side surface to which the photo receiver 1 is secured, and the wire 26 electrically connects a part of the wiring 24 for connection with the photo receiver, which is formed on the above-mentioned side surface of the photo receiver positioning member 2, to the photo receiver 1.

After the photo receiver 1 is secured to the photo receiver positioning member 2, the side surface of the photo receiver positioning member 2 to which the photo receiver 1 is secured is put in a horizontal position and the wire 26 is then connected between the wiring 24 for connection with the photo receiver and the photo receiver 1. Furthermore, after the sub-assembly that consists of the photo receiver positioning member 2 and the optical bench 3 is secured in the package 5, as shown in FIG. 6, the wire 25 is connected between the bonding pad 23 formed on the preamplifier 21 and the wiring 24 for connection with the photo receiver, as shown in FIG. 10. Therefore, in accordance with the first embodiment of the present invention, wire bonding can be performed between the photo receiver 1 and the preamplifier 21 by using a general wire-bonding apparatus.

Numerous variants may be made in the first embodiment mentioned above. The cross-sectional shape of each of the third and fourth grooves 33a and 33b is not limited to a letter V, and can alternatively be any one if the x coordinate of the midpoint of a straight-line segment that connects vertexes (or centroids) of the end portions of the third and fourth grooves 33a and 33b on the bonding surface 34 is accurately determined. Instead of the two grooves 33a and 33b, two simple marks, two notches, or the like which are formed on the bonding surface 34 of the optical bench 3 with them being in proper alignment with the first groove 31 can be used.

Furthermore, the first groove 31 formed on the optical bench 3 can be formed so that the first groove 31 is perpendicular to the bonding surface of the optical bench 3. However, in this case, it is necessary to prevent reflected light from returning to and entering the optical fiber 4 by taking measures such as machining of the end of the optical fiber 4 so that it is not perpendicular to but sloped relative to the optical axis of the optical fiber 4. In this case, since light refracts when emitted out of the end of the optical fiber 4, it is preferable to determine the spot center position in consideration of this refraction.

As mentioned above, in accordance with the first embodiment of the present invention, there is provided an optical module comprising an optical bench 3 having a first groove 31 formed in an upper surface thereof for positioning an optical fiber, a second groove 32 formed in the upper surface thereof, the second groove extending from a side surface thereof to the first groove 31 and being connected to the first groove 31, the second groove 32 having at least a part of a photo receiver 1 housed therein, and third and fourth grooves 33a and 33b formed in the upper surface thereof on both sides of the first groove 31 so that they are running at an equal distance from the first groove 31, and extending from the side surface thereof, the third and fourth grooves being of identical V-shaped cross-sectional shape, part of a side surface of a photo receiver positioning member 2 to which the photo receiver 1 is secured being securely bonded to a bonding surface of the optical bench 3. Accordingly, unlike a prior art optical module which is aligned and assembled based on the outside surface of a photo receiver positioning member which cannot be recognized with a high degree of accuracy through image recognition, the optical module of the first embodiment can be housed in a package with non-adjusting (passive alignment) mounting having a higher degree of accuracy which does not contain an error which occurs when bonding the photo receiver 1 to the photo receiver positioning member 2 and an error that occurs due to variations in the thickness of the optical bench 3. As a result, the optical module according to the first embodiment of the present invention is also applicable to a photo receiver having a smaller receiving diameter. In addition, the first embodiment offers an advantage of being able to perform wire bonding between the photo receiver 1 and a preamplifier 21 by using a general wire-bonding apparatus. Furthermore, the first embodiment offers another advantage of being able to implement surface mounting because the optical module is constructed by using the optical bench 3.

In addition, in the prior art optical module shown in FIG. 19, since the height of the photo receiver 60 in the direction of y-axis is uniquely determined by the connection between the upper surface of the stem 62 equipped with a V block and a fiber securing block and the bottom surface of the photo receiver mounting stem 61, the alignment accuracy in the direction of y-axis is determined by the accuracy of finishing of the stem 62 equipped with a V block and a fiber securing block, the accuracy of finishing of the photo receiver mounting stems 61, and the accuracy of mounting of the photo receiver 60. In contrast, in accordance with the first embodiment, since the accuracy of finishing of the photo receiver positioning member 2 and the accuracy of finishing of the optical bench 3 are not included in the alignment accuracy in the direction of y-axis, the alignment accuracy in the direction of y-axis can be improved as compared with the prior art optical module shown in FIG. 19.

Embodiment 2.

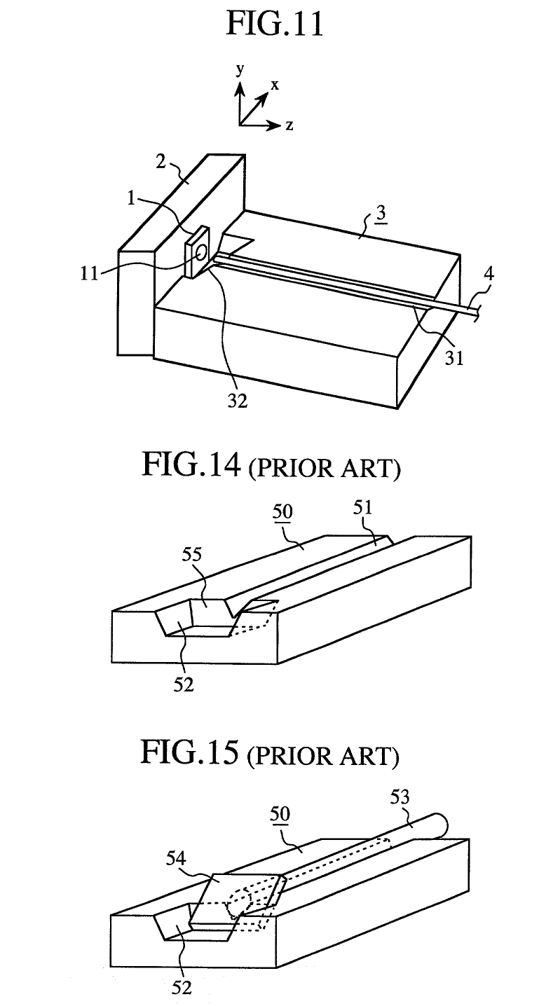

FIG. 11 is a perspective view showing a sub-assembly that consists of optical coupling components of an optical module according to a second embodiment of the present invention, which can be assembled through active alignment. In the figure, the same reference numerals as shown in FIG. 1 denote the same components as those of the above-mentioned first embodiment, and therefore the explanation of those components will be omitted hereafter. As can be seen from FIG. 11, the optical module according to the second embodiment of the present invention includes an optical bench 3 having the same structure as that of the optical module according to the above-mentioned first embodiment, except that it does have third and fourth grooves 33a and 33b of identical V-shaped cross-sectional shape for substantially indicating a spot center position.

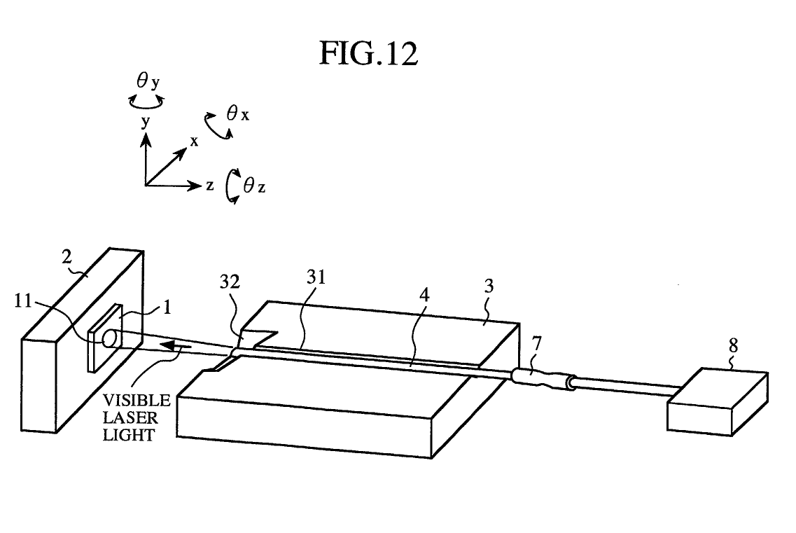

FIG. 12 is a perspective view showing a method of producing an optical module according to the second embodiment of the present invention. Next, a description will be made as to the method of producing an optical module according to the second embodiment of the present invention with reference to the figure.

In accordance with the method of producing an optical module according to the second embodiment, a photo receiver 1 having a receiving surface 11 is bonded to a suitable position of a side surface of a photo receiver positioning member 2 with solder or the like while positioning the photo receiver 1 relative to the photo receiver positioning member 2 (photo receiver securing step).

Next, an optical fiber 4 is placed in a first groove 31 formed in an upper surface of the optical bench 3. In addition, a visible laser light source 8 is connected to an end of the optical fiber 4 by way of an optical coupler 7 (light source connecting step). Both or either of the photo receiver positioning member 2 and the optical bench 3 is aligned so that visible laser light emitted out of the visible laser light source 8 and then emitted out the other end of the optical fiber 4 is incident upon the receiving surface 11 of the photo receiver 1 secured to the photo receiver positioning member 2. In this case, the photo receiver positioning member 2, to which the photo receiver 1 is bonded, is fixed to an arm (not shown in the figure) secured to a movement stage (also not shown in the figure) which can be moved on four axes (x, y, z, and θz), as in the above-mentioned first embodiment. At this time, it is assumed that the side surface of the photo receiver positioning member 2 which is a rectangular parallelepiped, to which the photo receiver 1 is bonded, is parallel with an xy plane. In other words, it is assumed that the photo receiver positioning member 2 has already been aligned so that the side surface of the photo receiver positioning member 2 becomes parallel with the xy plane. Furthermore, the optical bench 3 is fixed to another arm (not shown in the figure) secured to another movement stage (also not shown in the figure) which can be moved on the four axes (x, y, z, and θz) and which is different from the movement stage intended for alignment of the photo receiver positioning member 2. At this time, it is assumed that a bonding surface of the optical bench 3 is parallel to the xy plane. In other words, it assumed that the optical bench 3 has already been aligned so that the bonding surface of the optical bench 3 becomes parallel with the xy plane.

In addition, an image of a light spot produced on the receiving surface 11 of the photo receiver 1 by the visible laser light is taken with a camera not shown in the figure. An information processing device not shown in the figure, such as a computer, performs image processing, such as edge extraction processing and binarization processing, on the image of the light spot, which is taken with the camera, so as to produce a binary gray scale image, and then recognizes the shape of the light spot based on the binary gray scale image. As a result, both or either of the photo receiver positioning member 2 and the optical bench 3 is aligned so that the receiving surface 11 is in proper alignment with the center position of the light spot produced by the visible laser light (alignment step). After that, both or either of the photo receiver positioning member 2 and the optical bench 3 is moved so that they approach each other until the side surface of the photo receiver positioning member 2 to which the photo receiver 1 is secured touches the bonding surface of the optical bench 3. In addition, the photo receiver positioning member 2 and the optical bench 3 are finely aligned with respect to angles θx, θy, and θz, etc., and a part of the side surface of the photo receiver positioning member 2 to which the photo receiver 1 is secured is bonded to the bonding surface of the optical bench 3 with an adhesive such as a resin bond (securing step).

The first groove 31 formed on the optical bench 3 is not perpendicular to but sloped relative to the bonding surface of the optical bench 3, as in the above-mentioned first embodiment. Therefore, since the receiving surface 11 of the photo receiver 1 is parallel to the side surface of the photo receiver positioning member 2 bonded to the bonding surface of the optical bench 3, the optical axis of the optical fiber 4 positioned by the first groove 31 is not perpendicular to but sloped relative to the receiving surface 11 of the photo receiver 1. In general, in an optical module that contains a PD or the like, to prevent reflected light, which has been emitted out of the optical fiber and which has hit and reflected the receiving surface of the PD, from optically coupling and returning to the optical fiber again, the optical fiber is so aligned that the optical axis of the optical fiber is not perpendicular to but sloped relative to the receiving surface of the PD. In contrast, in accordance with the second embodiment of the present invention, since the first groove 31 for positioning the optical fiber 4 is so formed that it is sloped relative to the bonding surface of the optical bench 3, the optical fiber 4 will be automatically arranged with its optical axis being sloped relative to the receiving surface 11 of the photo receiver 1 at an accurately fixed angle when the photo receiver positioning member 2 to which the photo receiver 1, such as a PD, is secured is bonded to the bonding surface of the optical bench 3.

The first groove 31 needs not necessarily be sloped relative to the bonding surface of the optical bench 3. When the first groove 31 is so formed that it is perpendicular to the bonding surface of the optical bench 3, to prevent reflected light, which has been emitted out of the optical fiber and which has hit and reflected the receiving surface 11 of the photo receiver 1, from optically coupling and returning to the optical fiber 4 again, the end surface of the optical fiber 4 is so formed that the end surface of the optical fiber 4 is not perpendicular to but sloped relative to the optical axis of the optical fiber. In this case, since light refracts the end surface of the optical fiber 4 when emitted out of the optical fiber 4, it is necessary to determine the alignment of the photo receiver 1 with the optical fiber 4 in consideration with this refraction so that the light emitted out of the optical fiber 4 is optically coupled to the photo receiver 1 optimally.

In contrast, in the alignment step of the method of producing an optical module according to the second embodiment of the present invention, since the photo receiver positioning member 2 and the optical bench 3 are aligned based on the position of a light spot produced on the receiving surface 11 of the photo receiver 1 by visible laser light emitted out of an end of the optical fiber 4, it is possible to implement the best alignment automatically including adjustment for the refraction at the end of the optical fiber 4 without having to perform special alignment in consideration of the refraction at the end of the optical fiber 4.

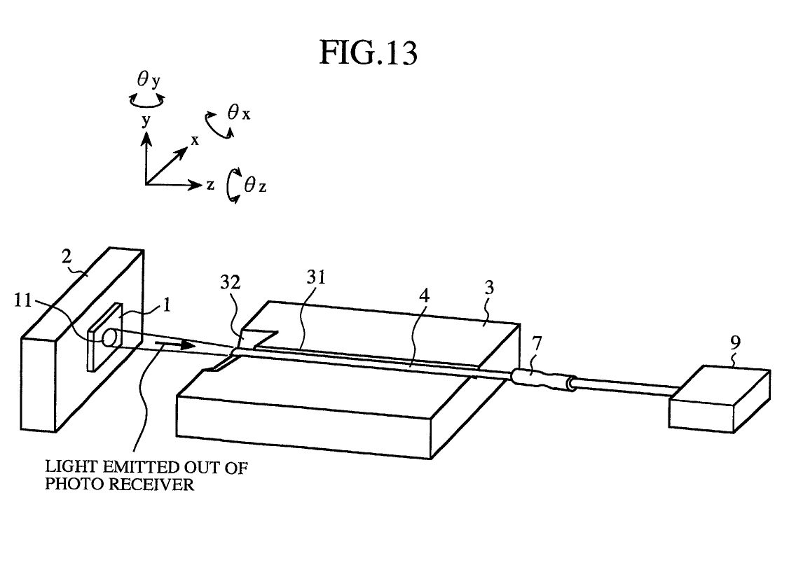

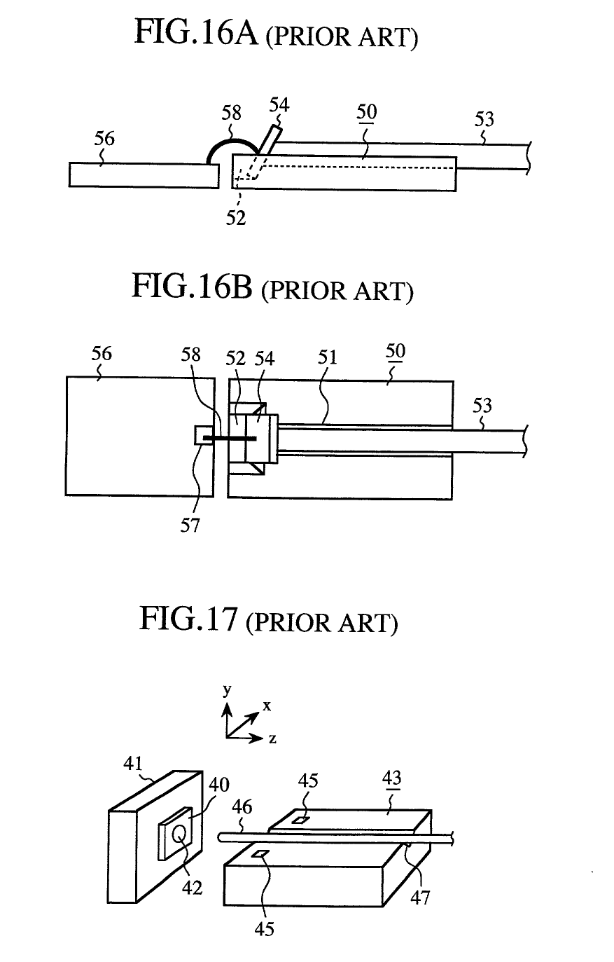

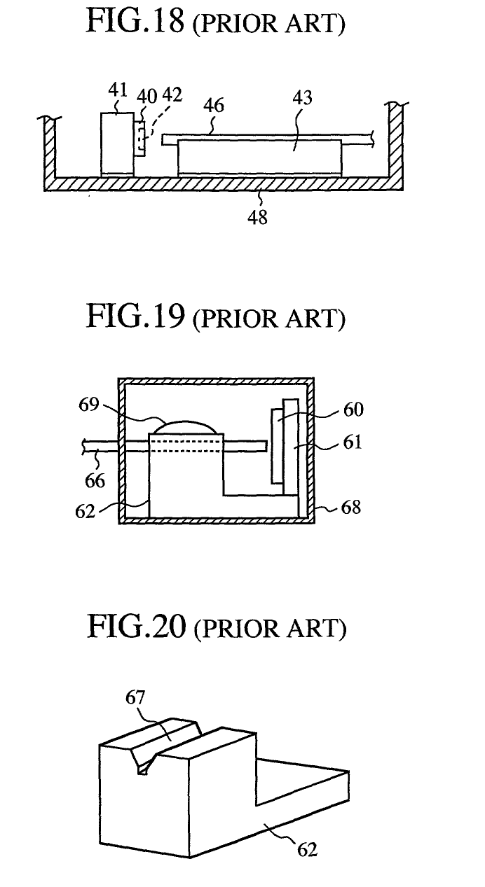

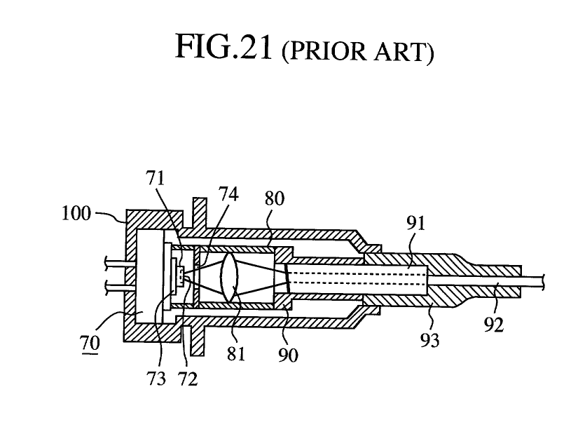

FIG. 13 is a perspective view showing a method of producing an optical module according to a variant of the second embodiment. In the figure, the same reference numerals as shown in FIG. 12 denote the same components as those of the above-mentioned second embodiment, and therefore the explanation of those components will be omitted hereafter.

In accordance with the method of this variant, the optical fiber 4 is placed in the first groove 31 formed on the optical bench 3 after the photo receiver securing step is complete. In addition, an optical power meter (optical receiver) 9 is connected to an end of the optical fiber 4 by way of an optical coupler 7 (optical receiver connecting step). A forward voltage is then applied to the photo receiver 1 which is a PD so as to cause the photo receiver 1 to emit light (PD light emission causing step), and both or either of the photo receiver positioning member 2 and the optical bench 3 is aligned so that light emitted out of the photo receiver 1 is incident upon the other end of the optical fiber 4. In addition, the amount of light emitted out of the photo receiver 1 is monitored by the optical power meter 9 connected to the end of the optical fiber 4 and both or either of the photo receiver positioning member 2 and the optical bench 3 is aligned so that the monitored amount of light is maximized (alignment step). After that, both or either of the photo receiver positioning member 2 and the optical bench 3 is moved so that they approach each other until the side surface of the photo receiver positioning member 2 to which the photo receiver 1 is secured touches the bonding surface of the optical bench 3. In addition, the photo receiver positioning member 2 and the optical bench 3 are finely aligned with respect to angles θx, θy, and θz, etc., and a part of the side surface of the photo receiver positioning member 2 to which the photo receiver 1 is secured is bonded to the bonding surface of the optical bench 3 with an adhesive such as a resin bond (securing step). Even in the method according to the variant of the second embodiment, when the other end of the optical fiber 4 is so formed that it is sloped relative to its optical axis for preventing reflected light from returning into the optical fiber 4, since light emitted out of the photo receiver 1 which is a PD refracts when optically coupled to the optical fiber 4, it is possible to implement the best alignment automatically including adjustment for the refraction at the other end of the optical fiber 4 so that the optimum optical coupling is provided.

As shown in FIG. 6, the sub-assembly assembled as previously mentioned of the optical module according to the second embodiment is secured in a package 5, as in the above-mentioned first embodiment. In this case, as in the above-mentioned first embodiment, the bottom surface of the photo receiver positioning member 2 which is a rectangular parallelepiped, which is perpendicular to the side surface to which the photo receiver 1 is secured, is located at a higher position than the bottom surface of the optical bench 3. As a result, the sub-assembly can be horizontally located with stability on an inner wall of the package 5 to which the sub-assembly should be secured. To secure the sub-assembly to the inner wall of the package 5, not only the bottom surface of the optical bench 3 but also the bottom surface of the photo receiver positioning member 2 are bonded to the inner wall of the package 5 with an adhesive 6. As a result, a big bonding area can be ensured and therefore sufficient adhesion can be provided.

After the photo receiver 1 is secured to the photo receiver positioning member 2, the side surface of the photo receiver positioning member 2 to which the photo receiver 1 is secured is put in a horizontal position and a wire 26 is then connected between wiring 24 for connection with the photo receiver and the photo receiver 1, as shown in FIGS. 10(a) to 10(c). Furthermore, after the sub-assembly that consists of the photo receiver positioning member 2 and the optical bench 3 is secured in the package 5, as shown in FIG. 6, a wire 25 is connected between a bonding pad 23 formed on a preamplifier 21 and the wiring 24 for connection with the photo receiver, as shown in FIGS. 10(a) to 10(c). Therefore, in accordance with the second embodiment of the present invention, wire bonding can be performed between the photo receiver 1 and the preamplifier 21 by using a general wire-bonding apparatus.

As mentioned above, in accordance with the second embodiment of the present invention, there is provided an optical module comprising an optical bench 3 having a first groove 31 formed in an upper surface thereof for positioning an optical fiber, and a second groove 32 formed in the upper surface thereof, the second groove extending from a side surface thereof to the first groove 31 and being connected to the first groove 31, the second groove 32 having at least a part of a photo receiver 1 housed therein, part of a side surface of a photo receiver positioning member 2 to which the photo receiver 1 is secured being securely bonded to a bonding surface of the optical bench 3. Accordingly, unlike a prior art optical module which is aligned and assembled based on the outside surface of a photo receiver positioning member which cannot be recognized with a high degree of accuracy through image recognition, the optical module of the first embodiment can be housed in a package through active alignment having a higher degree of accuracy which does not contain an error which occurs when bonding the photo receiver 1 to the photo receiver positioning member 2 and an error that occurs due to variations in the thickness of the optical bench 3. As a result, the optical module according to the second embodiment of the present invention is also applicable to a photo receiver having a smaller receiving diameter. In addition, the second embodiment offers an advantage of being able to perform wire bonding between the photo receiver 1 and a preamplifier 21 by using a general wire-bonding apparatus. Furthermore, the second embodiment offers another advantage of being able to implement surface mounting because the optical module is constructed by using the optical bench 3.

In the above-mentioned embodiments, the photo receiver 1 is not limited to a PD, and can alternatively be an APD (avalanche photodiode).

Many widely different embodiments of the present invention may be constructed without departing from the spirit and scope of the present invention. It should be understood that the present invention is not limited to the specific embodiments described in the specification, except as defined in the appended claims.

What is claimed is:

1. An optical module comprising:
a photo receiver having a receiving surface;
a first positioning member having a side surface to which said photo receiver is secured; and
a second positioning member having a first groove formed in an upper surface thereof for positioning an optical fiber, and a second groove formed in said upper surface thereof, said second groove extending from a side surface of said second positioning member to said first groove and being connected to said first groove, said photo receiver having partially housed in said second groove, and said side surface of said first positioning member being secured to said side surface of said second positioning member.

2. The optical module according to claim 1, wherein said second positioning member includes a position indicator for substantially indicating a position of a center of a light spot which is to be produced on said receiving surface of said photo receiver by light emitted out of an end of said optical fiber positioned by said first groove.

3. The optical module according to claim 2, wherein said position indicator of said second positioning member has two marks for substantially indicating an intersection where an optical axis of said optical fiber intersects with a plane including said side surface of said second positioning member.

4. The optical module according to claim 3, wherein said two marks are two grooves formed in said upper surface of said second positioning member on both sides of said first groove so that they are running at an equal distance from said first groove, said two grooves extending from said side surface of said second positioning member and being identical in cross-sectional shape.

5. The optical module according to claim 4, wherein said two grooves are V-shaped in cross section.

6. The optical module according to claim 2, wherein said photo receiver has a position indicator for indicating a center of said receiving surface.

7. The optical module according to claim 6, wherein said position indicator of said photo receiver is two marks disposed in the vicinity of said receiving surface.

8. The optical module according to claim 1, wherein said first groove is sloped relative to said side surface of said second positioning member to which said side surface of said first positioning member is secured.

9. The optical module according to claim 1, wherein said first positioning member is so sized that a bottom surface thereof perpendicular to said side surface thereof to which said photo receiver is secured is higher than a bottom surface of said second positioning member which is opposite to said upper surface of said second positioning member in which said first groove is formed.

10. The optical module according to claim 1, wherein said second positioning member is constructed of a silicon substrate.

11. The optical module according to claim 1, wherein a part of said side surface of said first positioning member is bonded to said side surface of said second positioning member with an adhesive.

12. The optical module according to claim 1, further comprising a package having an inner wall to which a bottom surface of said second positioning member and a bottom surface of said first positioning member are bonded, for housing said first and second positioning members.

13. A method of producing an optical module, comprising the steps of:
securing a photo receiver to a side surface of a first positioning member;
measuring a position of a receiving surface of said photo receiver secured to said first positioning member;
substantially measuring a position of a center of a light spot which is to be produced on said receiving surface of said photo receiver by light emitted out of an end of an optical fiber to be positioned by a first groove formed in an upper surface of a second positioning member;
based on the measured position of said receiving surface of said photo receiver and the measured position of the center of the light spot, aligning said first positioning member and said second positioning member with each other; and
securing said side surface of said first positioning member and a side surface of said second positioning member to each other after said aligning step is completed.

14. The optical module producing method according to claim 13, wherein the light spot position measuring step is the step of substantially measuring the position of the center of the light spot by using a position indicator formed in said second positioning member, for substantially indicating the position of the center of the light spot which is to be produced on said receiving surface of said photo receiver by light emitted out of an end of an optical fiber to be positioned by said first groove.

15. The optical module producing method according to claim 14, wherein said position indicator has two marks for substantially indicating an intersection where an optical axis of said optical fiber intersects with a plane including said side surface of said second positioning member.

16. The optical module producing method according to claim 15, wherein said two marks are two grooves formed in said upper surface of said second positioning member on both sides of said first groove so that they are running at an equal distance from said first groove, said two grooves extending from said side surface of said second positioning member and being identical in cross-sectional shape.

17. The optical module producing method according to claim 15, wherein the light spot position measuring step is the step of producing an image of said two marks, performing image processing on the produced image so as to measure positions of said two marks, and determining the position of the center of the light spot based on a position of a midpoint between the measured positions of said two marks.

18. The optical module producing method according to claim 13, wherein said receiving surface position measuring step is the step of measuring the position of said receiving surface based on a shape of said receiving surface of said photo receiver.

19. The optical module producing method according to claim 18, wherein said receiving surface position measuring step is the step of producing an image of said photo receiver, recognizing the shape of said receiving surface by performing image processing on the produced image, and setting a centroid of the shape to be the position of said receiving surface.

20. The optical module producing method according to claim 13, wherein said receiving surface position measuring step is the step of measuring the position of said receiving surface by measuring positions of two marks formed on said photo receiver in advance.

21. The optical module producing method according to claim 20, wherein said receiving surface position measuring step is the step of measuring the positions of said two marks by producing an image of said two marks and performing image processing on the produced image.

22. The optical module producing method according to claim 13, wherein said securing step is the step of securing a part of said side surface of said first positioning member and said side surface of said second positioning member to each other by bonding the part of said side surface of said first positioning member to said side surface of said second positioning member.

23. A method of producing an optical module, comprising the steps of:
securing a photo receiver to a first positioning member;
placing an optical fiber in a groove formed in an upper surface of a second positioning member and connecting a laser light source to an end of said optical fiber;
aligning said first positioning member and said second positioning member with each other so that laser light emitted out of said laser light source and then output from another end of said optical fiber is optimally incident upon said photo receiver; and
securing said aligned first and second positioning members to each other after said aligning step is completed.

24. A method of producing an optical module, comprising the steps of:
securing a photo diode to a first positioning member;
placing an optical fiber in a groove formed in an upper surface of a second positioning member and connecting an optical receiver that outputs a signal corresponding to light received to an end of said optical fiber;
causing said photo diode to emit light by applying a forward voltage to said photo diode;
aligning said first positioning member and said second positioning member with each other so that the light emitted out of said photo diode is incident upon another end of said optical fiber, and further aligning said first positioning member and said second positioning member with each other according to a signal output from said optical receiver; and
securing said aligned first and second positioning members to each other after said aligning step is completed.
